(19) United States
(12) Patent Application Publication
(10) Pub. No.: US 2016/0182152 A1
(43) Pub. Date: Jun. 23, 2016

(54) BIT ERROR RATIO OPTIMIZATION METHOD AND APPARATUS

(71) Applicant: Alcatel-Lucent USA Inc., Murray Hill, NJ (US)

(72) Inventors: Lev Sofman, Murray Hill, NJ (US); David J. Butler, Murray Hill, NJ (US)

(21) Appl. No.: 14/579,395

(22) Filed: Dec. 22, 2014

(51) Int. Cl. H04B 10/2513; H04B 10/079

(52) U.S. Cl. CPC H04B 10/2513; H04B 10/07953

(57) ABSTRACT

A method includes determining a first subset of a set of optical channels, wherein each channel of the first subset has a bit error ratio (BER) greater than each channel of a remaining subset of the channels. A second subset of the set of optical channels is determined, wherein each channel of the second subset has a BER less than each channel of the remaining subset of the channels. Input power level (P) and/or dispersion compensation (D) of one or more of the channels of the first subset is adjusted, thereby reducing an aggregate BER of the first subset. P and/or D of one or more of the channels of the second subset is adjusted, thereby increasing an aggregate BER of the second subset. A reduction of an aggregate BER of the set of optical channels results from the adjusting of the first and second subsets.

### TECHNICAL FIELD OF THE INVENTION

The invention relates, in general, to optical communication systems and to methods of using and manufacturing such systems.

### BACKGROUND OF THE INVENTION

This section introduces aspects that may help facilitate a better understanding of the inventions. Accordingly, the statements of this section are to be read in this light and are not to be understood as admissions about what is prior art or what is not prior art.

With ever-increasing densities of digital information being communicated over optical communication networks, there is a continuing need to reduce the bit error ratio (BER, also known as bit error rate) in data communicated over such systems.

### SUMMARY OF THE INVENTION

One embodiment is a method comprising adjusting input power (P) and electronic dispersion compensation (D) applied to one or more channels of a set of optical channels, including performing a constellation phase procedure. The constellation phase procedure can include for each of the channels, measuring a bit error ratio (BER) that results from a starting PD value pair corresponding to that channel. The constellation phase procedure can include selecting a top subset of the channels each having a higher BER than remaining channels in the set of channels, and selecting a bottom subset of the channels each having a lower BER than the remaining channels in the set/The constellation phase procedure can include calculating, for each channel of the top and bottom subsets, a constellation set of P and D values that includes the starting pair of P and D values corresponding to that channel and a changed set of P and D values corresponding to that channel, wherein for each member of each changed set one or both of P and D are incremented or decremented from the corresponding starting pair of P and D values. The constellation phase procedure can include measuring, for each of the optical channels of the top and bottom subsets, the BER of that channel after applying each one of the pairs of P and D values of the corresponding constellation set to each one of the top subset of channels and applying corresponding oppositely signed changed P values to the bottom subset of channels. The constellation phase procedure can include choosing the P and D values of the constellation set that results in a lowest maximum BER among the channels as a best constellation PD set

In some such embodiments, the best constellation PD set can be a single pair of P and D values that results in a lowest maximum BER over all of the channels. In some such embodiments, the best constellation PD set can include multiple pairs of P and D values that result in a lowest maximum BER for each one of the top subset of channels. In any embodiments, during the measurements of the BERs for each of the channels, the starting pair of P and D values can be applied to the remaining subset of channels. In any embodiments, the best constellation PD set can used as the starting pair of P and D values in a second iteration of the constellation phase procedure.

In any embodiments, adjusting of the P and the D applied to the channels can further include performing an extension phase procedure. The extension phase procedure can include calculating a change vector of P and D values equal to the difference between the best constellation PD set and the starting pair of P and D values. The extension phase procedure can include adding the change vector to the best constellation PD set to produce an extension PD set. The extension phase procedure can include measuring the BERs for each of the channels after applying each one of the pairs of P and D values of the extension PD set to each one of the top subset of channels and applying corresponding oppositely signed changed P values to the bottom subset of channels. The extension phase procedure can include choosing the P and D values of the extension PD set as a best extension phase set if the lowest maximum BER among the channels when applying the extension PD set is less than the lowest maximum BER when applying the best constellation PD set.

In some such embodiments, the best extension PD set can be used as the starting pair of P and D values in a second iteration of the constellation phase procedure. Some such embodiments can further include performing a second iteration of the extension phase procedure. The second iteration of the extension phase procedure can include adding the change vector to the best extension phase set to produce a second extension PD set. The second iteration of the extension phase procedure can include measuring the BERs for each of the channels after applying the pairs of P and D values of the second extension PD set to each one of the top subset of channels and applying corresponding oppositely signed changed P values to the bottom subset of channels. The second iteration of the extension phase procedure can include choosing the P and D values of the second extension PD set as a best second extension phase set if the lowest maximum BER among the channels when applying the second extension PD set is less than the lowest maximum BER when applying the best extension PD set. In some such embodiments, the best second extension PD set can be used as the starting pair of P and D values in a second iteration of the constellation phase procedure.

Another embodiment is an apparatus. The apparatus comprises an optical channel balancing control module electrically configured to be connected to an optical receiver module and to an optical transmitter module. A computing unit of the control module can be configured to send electrical control signals to the optical transmitter module to adjust input power levels (P) and electronic dispersion compensation (D) to channels of optical signal streams transmitted from the optical transmitter module to the optical receiver module. the adjusted P and the D values are determined by a computer algorithm embodied in a computer program executed by the computing unit, the algorithm including a constellation phase procedure. The constellation phase procedure can include measuring bit-error-ratios (BER) for each of the channels of the optical signal streams transmitted to the receiver module, for a starting pair of P and D values applied to each one of the optical signal streams of the channels. The constellation phase procedure can include ordering the channels by measured BER.

The constellation phase procedure can include selecting a top subset of the channels each having a corresponding BER greater than a remaining subset of the channels, and selecting a bottom subset of the channels each having a corresponding BER less than the remaining subset of the channels. The constellation phase procedure can include selecting a top subset of the channels each having a corresponding BER greater than a remaining subset of the channels, and selecting a bottom subset of the channels each having a corresponding BER less than the remaining subset of the channels. The constellation phase procedure can include calculating a constellation set of P and D values that includes the starting pair of P and D values and a set of changed P and D values, wherein for each member of the changed set one or both of P and D are incremented or decremented away from the starting pair of P and D values. The constellation phase procedure can include measuring the BERs for each of the channels after applying each one of the pairs of P and D values of the constellation set to each one of the top subset of channels and applying corresponding oppositely signed changed P values to the bottom subset of channels. The constellation phase procedure can include choosing the P and D values of the constellation set that resulted in a lowest maximum BER among the channels as a best constellation PD set

In some such embodiments, the best constellation PD set can be a single pair of P and D values that results in a lowest maximum BER over all of the channels. In some such embodiments, the best constellation PD set can include multiple pairs of P and D values that result in a lowest maximum BER for each one of the top subset of channels. In any embodiments, during the measurements of the BERs for each of the channels, the starting pair of P and D values is applied to the remaining subset of channels.

In any embodiments, adjusting the P and the D applied to the channels further can include performing an extension phase procedure in the computing unit. The extension phase procedure can include calculating a change vector of P and D values equal to the difference between the best constellation PD set and the starting pair of P and D values. The extension phase procedure can include adding the change vector to the best constellation PD set to produce an extension PD set. The extension phase procedure can include. The extension phase procedure can include measuring the BERs for each of the channels after applying each one of the pairs of P and D values of the extension PD set to each one of the top subset of channels and applying corresponding oppositely signed changed P values to the bottom subset of channels. The extension phase procedure can include choosing the P and D values of the extension PD set as a best extension phase set if the lowest maximum BER among the channels when applying the extension PD set is less than the lowest maximum BER when applying the best constellation PD set.

In any embodiments, the channel balancing control module can be part of the apparatus configured as an optical communication system, and the system can further include the optical transmitter module, the optical transmitter module including one or more modulators that are configured convert digital electrical signal streams into the optical signal streams. In any such embodiments, the modulators can include transponders or transceivers configured to encode the digital electrical signal into the optical signal stream by altering one or more of the phase, amplitude or polarity of the optical signal stream. In any such embodiments, the optical transmitter module can include at least one of a power attenuator configured to adjust the P or an electronic dispersion compensator configured to adjust the D, as instructed by the computing unit. In any such embodiments, the channel balancing control module can be part of the apparatus configured as an optical communication system, and the system further including the optical receiver module, wherein the optical receiver module includes one or more transponders or transceivers that are configured convert the optical signal streams into digital electrical signal streams. In any such embodiments, the channel balancing control module can be part of the apparatus configured as of an optical communication system, and the system further including an optical multiplexer configured to combine and multiplex the optical signal streams of the channels into a single wavelength division multiplexed (WMD) optical stream and send the single WMD optical signal stream through one or more optical fiber spans to an optical demultiplexer of the system, the optical demultiplexer configured to separate and demultiplex the single WMD optical signal stream into separate optical streams that are received by the optical receiver module. In some such embodiments, the optical multiplexer includes at least one of a power attenuator configured to adjust the P or an electronic dispersion compensator configured to adjust the D, as instructed by the computing unit.

Another embodiment is another method. The method can comprise determining a first subset of a set of optical channels, each channel of the first subset having a bit error ratio (BER) greater than each channel of a remaining subset of the channels. The method can comprise determining a second subset of the set of optical channels, each channel of the second subset having a BER less than each channel of the remaining subset of the channels. The method can comprise adjusting input power level (P) and/or dispersion compensation (D) of one or more of the channels of the first subset thereby reducing an aggregate BER of the first subset. The method can comprise adjusting P and/or D of one or more of the channels of the second subset, thereby increasing an aggregate BER of the second subset. A reduction of an aggregate BER of the set of optical channels results from the adjusting of the first and second subsets. In some such embodiments, an aggregate power level of the set of optical channels remains about equal before and after the adjusting.

Another embodiment is another apparatus. The apparatus can comprise a computing unit. The apparatus can comprise a non-transitory computer-readable storage medium having instructions stored thereon that when executed by the computing unit configure the computing unit. The computing unit can be configured to determine a first subset of a set of optical channels, each channel of the first subset having a bit error ratio (BER) greater than each channel of a remaining subset of the channels. The computing unit can be configured to determine a second subset of the set of optical channels, each channel of the second subset having a BER less than each channel of the remaining subset of the channels. The computing unit can be configured to adjust input power level (P) and/or dispersion compensation (D) of one or more of the channels of the first subset thereby reducing an aggregate BER of the first subset. The computing unit can be configured to adjust P and/or D of one or more of the channels of the second subset, thereby increasing an aggregate BER of the second subset. A reduction of an aggregate BER of the set of optical channels results from the adjusting of the first and second subsets.

### BRIEF DESCRIPTION OF THE DRAWINGS

The embodiments of the disclosure are best understood from the following detailed description, when read with the accompanying FIGUREs. Some features in the figures may be described as, for example, “top,” “bottom,” “vertical” or “lateral” for convenience in referring to those features. Such descriptions do not limit the orientation of such features with respect to the natural horizon or gravity. Various features may not be drawn to scale and may be arbitrarily increased or reduced in size for clarity of discussion. Reference is now made to the following descriptions taken in conjunction with the accompanying drawings, in which:

FIG. 1 presents a flowchart illustrating, in overview, selected steps in a method of minimizing bit-error-rate in accordance with the present disclosure;

FIG. 2 presents a flowchart illustrating selected steps in the constellation phase part of the method of minimizing bit error ratio such as any of the method embodiments include those discussed in the context of FIG. 1;

FIG. 3 graphically illustrates an example constellation set of power and dispersion values such as discussed in the context of FIGS. 1 and 2;

FIG. 4 presents a chart to illustrates aspects of example embodiments, implementing the constellation phase part of the method, such as discussed in the context of FIGS. 1 and 2;

FIG. 5 presents a flowchart illustrating selected steps in the extension phase part of the method of minimizing bit error ratio such as any of the method embodiments, including those discussed in the context of FIG. 1;

FIG. 6 illustrates an example implementation the method of minimizing bit error ratio presenting example stages constellation extension phase part of the method at various intermediate iterations the method such as discussed in the context of FIGS. 1-5; and

FIG. 7 presents a block diagram of an example apparatus that can use the method of optimizing the bit rate as disclosed herein including any of the embodiments of the method discussed in the context of FIGS. 1-6.

In the Figures and text, unless otherwise indicated, similar or like reference symbols indicate elements with similar or the same functions and/or structures.

In the Figures, unless otherwise indicated, the relative dimensions of some features may be exaggerated to more clearly illustrate one or more of the structures or features therein.

Herein, various embodiments are described more fully by the Figures and the Detailed Description. Nevertheless, the inventions may be embodied in various forms and are not limited to the embodiments described in the Figures and Detailed Description of Illustrative Embodiments.

### DETAILED DESCRIPTION OF ILLUSTRATIVE EMBODIMENTS

The description and drawings merely illustrate the principles of the inventions. It will thus be appreciated that those skilled in the art will be able to devise various arrangements that, although not explicitly described or shown herein, embody the principles of the inventions and are included within its scope. Furthermore, all examples recited herein are principally intended expressly to be for pedagogical purposes to aid the reader in understanding the principles of the inventions and concepts contributed by the inventor(s) to furthering the art, and are to be construed as being without limitation to such specifically recited examples and conditions. Moreover, all statements herein reciting principles, aspects, and embodiments of the inventions, as well as specific examples thereof, are intended to encompass equivalents thereof. Additionally, the term “or,” as used herein, refers to a non-exclusive or, unless otherwise indicated. Also, the various embodiments described herein are not necessarily mutually exclusive, as some embodiments can be combined with one or more other embodiments to form new embodiments.

Embodiments as further disclosed herein optimize the BER for optical communication systems such as terrestrial and submerged long haul wavelength division multiplexing (WDM) networked systems (e.g., a long-haul optical fiber network). Embodiments of the disclosure implement a learning algorithm that can simultaneously adjust the relative power (P), and, electronic dispersion compensation (D) applied to optical signals of optical channels so as to minimize the maximum BER encountered by the network. Power adjustment and dispersion compensation are performed prior to optical amplification and transmission of the optical signals through optical fibers of the network.

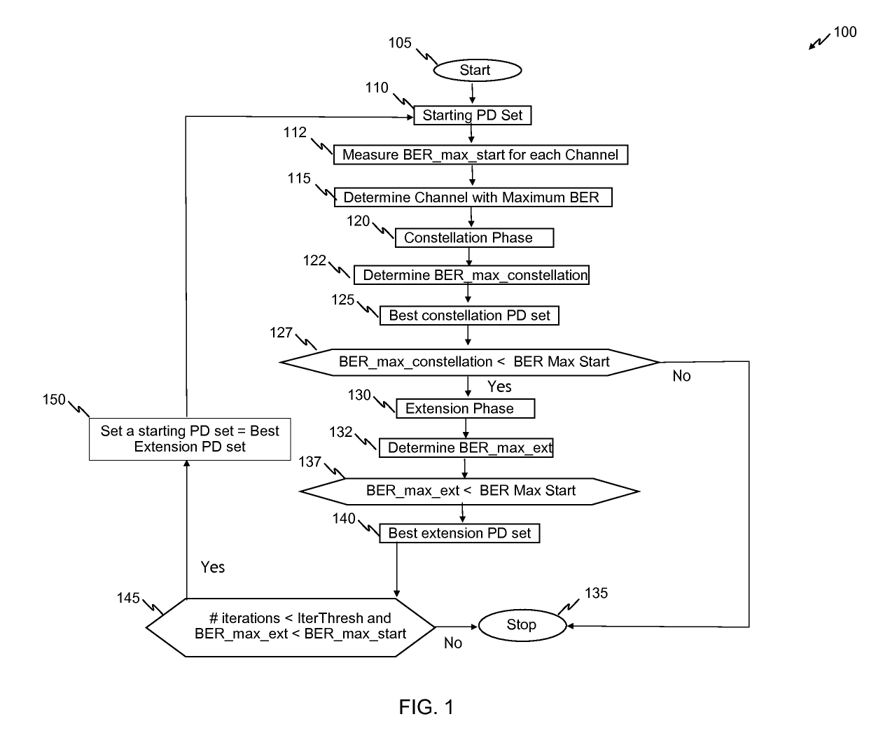

FIG. 1 presents a flowchart illustrating, in overview, selected steps in a method 100 of minimizing BER in accordance with the present disclosure. With continuing reference to FIG. 1 throughout, commencing at start step 105, in step 110, a starting set of P and D values (“starting PD set”) is defined, e.g., for which each of a plurality of optical channels is associated with a corresponding PD value pair. In step 112, the BER for each one of the optical channels is measured, e.g., at a receiver end of the network, with the starting set of P and D values applied, e.g., with each PD value pair applied to its corresponding optical channel. The BER is measured for each of the channels, e.g., all the channels of the optical network, for a starting pair of P and D values applied to each one of the channels. The channel with the maximum BER within the starting set of P and D values (“BER_max_start”) applied is determined in step 115.

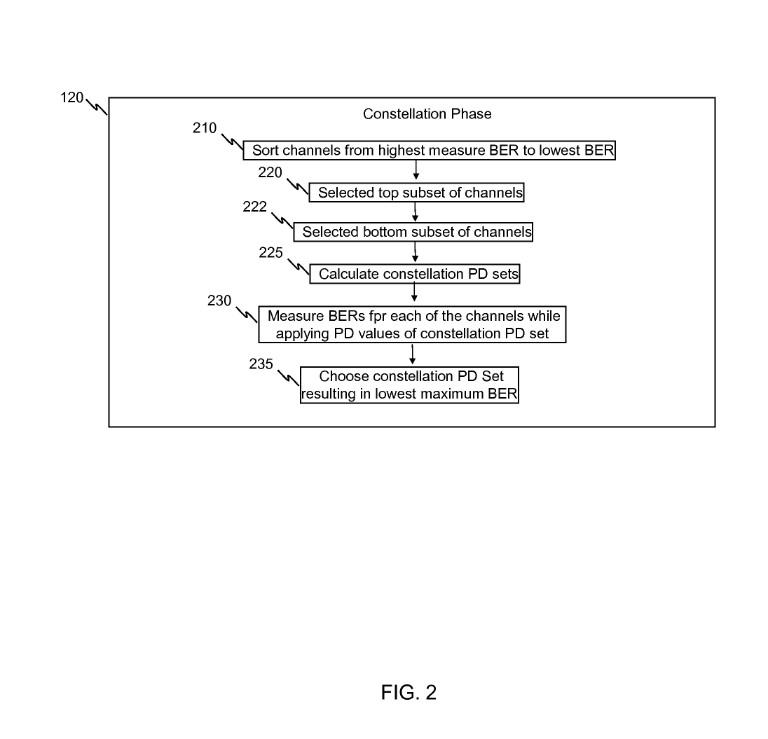

As further explained below in the context of FIGS. 2-4, optimization of BER is facilitated by implementing a constellation phase part of the algorithm in step 120 (“constellation phase”). The constellation phase can include applying PD values which are changed by both positive amounts (e.g., an increment) and negative amounts (e.g., a decrement) around the starting PD set to form constellation sets. Coordinates, e.g. Cartesian coordinates, of the changed P and D pairs corresponding to these constellation sets are sometimes referred to herein as a PD constellation or a constellation PD set. PD constellations can be generated for a subset or subgroup of the channels having the highest BERs among the total set or group of channels, e.g., in some cases subject to a fixed total power through all channels, by adjustment of power levels for another subset or subgroup of the channels having the lowest BERs among the total set or group of channels.

As illustrated in FIG. 1, the PD pair, or in some embodiments, PD pairs, of the PD constellation are determined in step 122 to have a corresponding lowest measured maximum of BER measured, e.g., as the sum, or aggregate, among all of the channels (“BER_max_constellation”). The constellation set having lowest maximum BER is taken to be a best constellation PD set in step 125. If, in decision step 127, it is determined that BER_max_constellation (step 122) is less than BER_max_start (step 112) then the method proceeds to an “extension phase” part of the algorithm in step 130. If, in decision step 127, it is determined that BER_max_constellation (step 122) is greater than or equal to BER_max_start (step 112) then the method is terminated at stop step 135.

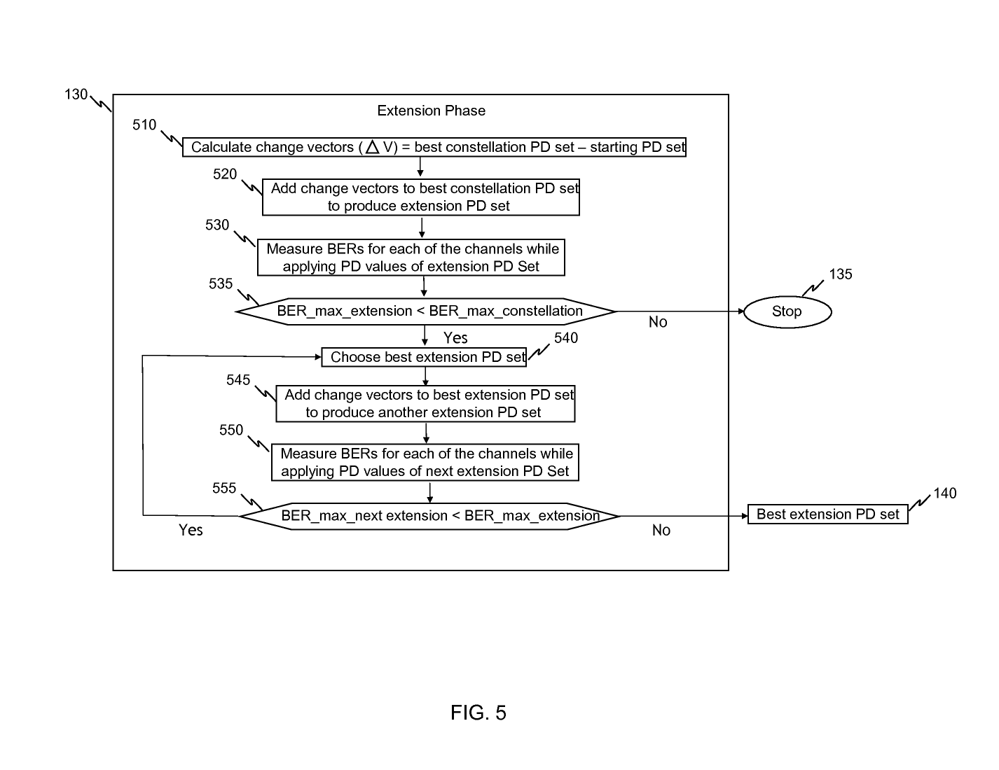

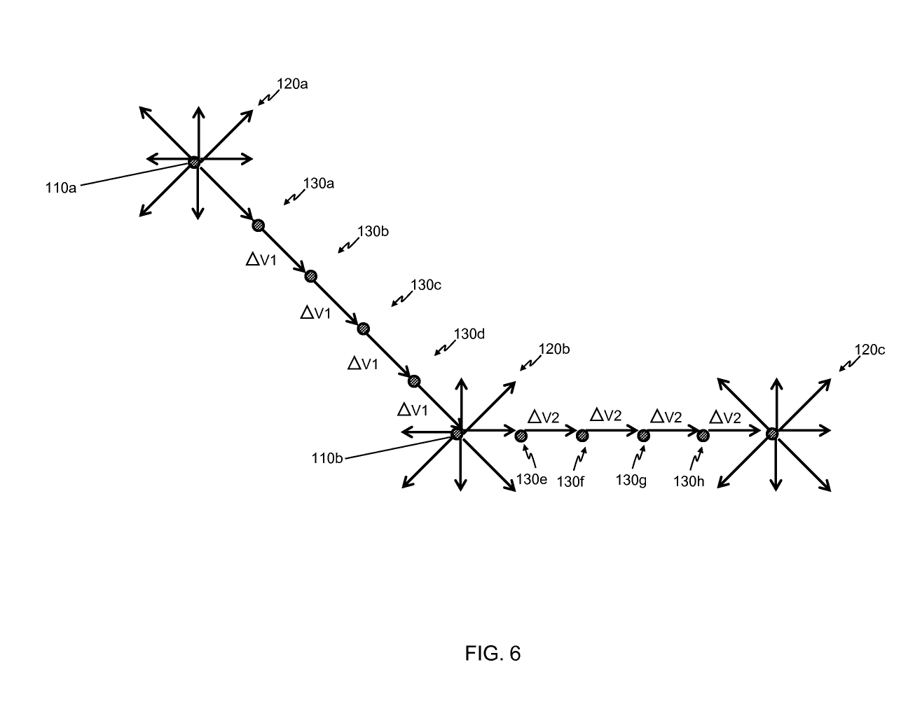

As further illustrated in FIG. 1, and further explained below in the context of FIGS. 5-6, in some embodiments of the method 100, BER optimization can be further improved by implementing an extension phase part of the algorithm in step 130 (“extension phase”). Embodiments of the extension phase can include measuring the BER for one or more sets of PD values that are extended in the same direction (according to a change vector as further described elsewhere herein) as the constellation phase PD set that was determined to be the best constellation PD set (step 125). If the measured maximum BER using the extended phase PD set (BER_max_ext, step 132) is determined in step 137 to be lower than the sum of measured BERs for the best constellation PD set (BER_max_constellation) then the extended PD set is designated as a best extension PD set (step 140). Otherwise, in step 140 the P and D values of the best extension PD set are equal to the P and D values of the best constellation PD set. As further explained below, in the context of FIGS. 5-6, in some embodiments, repetition of the extension phase can lead to a still better extension PD set with a corresponding lower BER and new best extension PD set.

As further illustrated in FIG. 1, in some embodiments of the method 100, iteratively repeating the constellation and extension phases can facilitate further optimization of the BER. For instance, in some embodiments, if in decision step 145 it is determined that the number of iterations is less than a maximum threshold of iterations (#iterations <IterThresh), and, that the BER corresponding to the best extension (“PD set BER_max_ext”) is less than the maximum BER with the starting set of P and D values (BER_max_start, step 115), then another iteration is performed. In such instances, in step 150, the starting set of P and D values applied in step 105 is reset to the best extension PD set.

FIG. 2 presents a flowchart illustrating further details of embodiments of the constellation phase part of the method 100 (e.g., step 120) after selecting the starting PD set for the channel with the maximum measured BER (BER_max_start, step 110).

As illustrated in FIG. 2, in some embodiments, the constellation phase (step 120) includes a step 210 of sorting the channels from the highest measured BER to the lowest measured BER. Embodiments of the constellation phase (step 120) can also include a step 220 of selecting a top subset of the channels (e.g., m channels of a total of N channels in the network, where m is less than N) having higher (e.g., in some cases the highest) BERs than a remaining subset of the channels. Embodiments of the constellation phase (step 120) can also include a step 222 of selecting a bottom subset of the channels (e.g., k channels where is less than N) having a lower (and in some cases the lowest) BERs than a remaining subset of the channels. In some embodiments, adjusting power levels of the channels to provide a constant total power, as further described below, is facilitated by selecting the number of channels in the bottom subset so as to equal to the number of channels in the top subset (e.g., =m).

Embodiments of the constellation phase (step 120) further include a step 225 of calculating a constellation set of P and D values. The constellation set of P and D values includes the starting pair of P and D values (e.g., starting PD set, step 110) and a set of changed P and D values, wherein for each member of the changed set one or both of P and D are positively or negatively adjusted (e.g., incremented or decremented away) from the starting pair of P and D values.

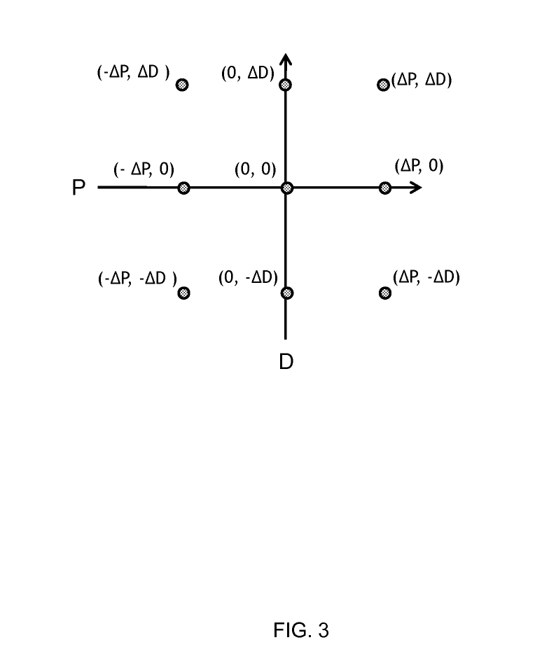

FIG. 3 graphically illustrates an example constellation set of power and dispersion values, showing the nine P and D pairs of the constellation where P and D are incremented by incremental amounts, ±ΔP and ±ΔD, about the starting pair of P and D values which are represented at the origin of the constellation with zero increments of both P and D (e.g., pair (0,0) in FIG. 3).

As part of step 225, the power and electronic dispersion compensation with the incremented/decremented values (e.g., ±ΔP and ±ΔD) applied are checked to ensure that they are still within allowed ranges feasible for the optical equipment used to implement these changes. For example, an amplifier module of an optical network can be equipped with variable optical attenuators, transponders or electronic dispersion compensators which each have preferred limits on the amounts of maximum P and D that they can launch into a channel. For example, the amplifier module will preferably provide a minimal level of amplification sufficient to lock the optical gain or power of the channels.

The sizes (e.g., magnitude) of the ±ΔP and ±ΔD values depends upon the particular characteristics of the optical network being optimized. Such characteristics can include the number of channels, the signal-to-noise ratios of the channels, and/or whether or not there are preexisting, dispersion compensators (e.g., optical dispersion compensators) connected to the network. The size of the ±ΔP and ±AD values selected and applied will also depend upon the numbers of channels in the top and bottom subgroups, the amount of time available (e.g., minutes versus hours) to optimize the network and the tolerance of BER accepted for the network. Additionally, the size of the incremental ±ΔP and ±ΔD values are selected such that the BER of one or more of the channels is different than the BER measured using the starting PD set.

As non-limiting examples, for certain optical networks having about 40 to 60 channels and with about top and bottom channel subsets or subgroups each having about 5-10 channels, the incremental power level can correspond to about 0.001, about 0.01, about 0.05 or about 0.1 dB and the incremental electronic dispersion compensation can correspond to about 1 ps/nm, 10 ps/nm, 50 ps/nm, or 100 ps/nm. The smaller the incremental value of ΔP and ΔD, the more accurate the final optimization will be, but, the longer it will take to arrive at the final optimization.

As further illustrated in FIG. 2, the constellation phase (step 120) further includes a step 230 of measuring the BERs for each of the channels (e.g., all channels of the optical network) after applying each one of the pairs of P and D values of the constellation set to each one of the channels of the top subset of channels and applying corresponding oppositely signed changed P values to channels of the bottom subset of channels. For instance, as illustrated in FIG. 3, there are three pairs of P and D values of the constellation set (e.g., pairs (0, ΔD), (0,0) and (0, −ΔD)) where the power level of the top subset of channels is not changed and six P and D values of the constellation set (e.g., pairs (−ΔP, ΔD), (ΔP, ΔD), (−ΔP, 0), (ΔP, 0), (−ΔP, −ΔD) and (ΔP, −ΔD)) where the power level of the top subset of channels is changed. In some such embodiments, the same magnitude but oppositely signed changed P value can be applied to six channels of the bottom subset of channels. In some embodiments, any one of the same magnitude but oppositely signed changed P values, (e.g., +ΔP or −ΔP), can be randomly applied to any one of the six channels in the bottom subset so long as it corresponds in magnitude to one of the increment (e.g., −ΔP or +ΔP) applied to one of the top subset of channels. In other embodiments, the same magnitude but oppositely signed changed P value can be applied to the one channel in the bottom subset that is in a same but oppositely or inverse ordered sequence as the corresponding one of the top subset of channels to which the power increment is applied.

Consider for instance, an example network have 50 channels (N=50) and the top subset and lower are selected to have channels (m=5, and =5, respectively). In some embodiments, the channels of the full set of channels are ranked from 1 to 50 in order of decreasing BER. However, in other embodiments, the channels may be ranked in order of increasing BER with appropriate adjustment to the described embodiments. In the former of such embodiments, when an increment of +ΔP is applied to the sorted channel having the highest BER (designated as “sorted channel 1”) then the corresponding increment of −ΔP is applied to the sorted channel having the lowest BER (designated as “sorted channel 50”). If the channel with the second highest BER (designated as “sorted channel 2”) is incremented by +ΔP then the channel with the second lowest (e.g., 49th highest) BER (designated as “sorted channel 49”) is decremented by −ΔP. Similar corresponding adjustments are made between the power levels of the channels with the third, fourth and fifth highest BERs, and, the channels with the 48th, 47th and 46th highest BERs, respectively. In other embodiments, however, when the power level of any one change of the top subgroups of channels (e.g., channels 1 through 5) is adjusted by ±ΔP then the same magnitude but oppositely sign of power adjustment can be made among anyone of the bottom subgroups of channels. For instance, if the channel with the first and second highest BER are incremented and decremented by +ΔP, and −ΔP, respectively, then any of the two channels of the bottom subgroup (e.g., the 47th and 46th channels, or, 46th and 45th channels, etc. . . . ) can be selected for opposite magnitude decremental and incremental adjustments (e.g., by −ΔP, and +ΔP) respectively.

The constellation phase (step 120) further includes a step 235 of choosing the P and D values of the constellation set that result in a lowest maximum BER of the channels (e.g., among all of the channels of the network) as the best constellation PD set (step 125).

In some embodiments, the best constellation PD set, chosen as part of step 235, is the single pair of the P and D values of the constellation set applied to the top subset of channels which results in a lowest maximum BER over all of the channels (e.g., all channels of the network). Such embodiments can facilitate rapid optimization to a best constellation PD set (step 125).

In other embodiments, the best constellation PD set, chosen as part of step 235, includes multiple pairs of the P and D values that result in a lowest maximum BER for each channel of the top subset of the channels. This embodiment can facilitate finding a best constellation PD set (step 125) with a lower maximum BER over all of the channels, e.g., than the previously described embodiment, but, can take a longer period of computation to arrive at the best constellation PD set.

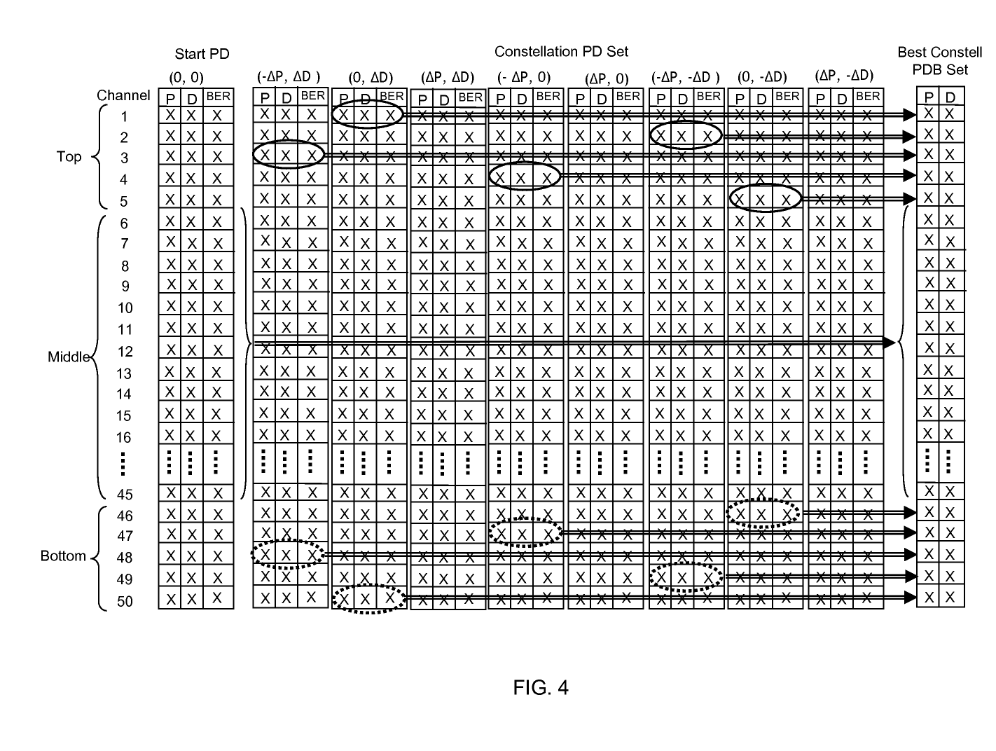

Further aspects of an example embodiment of the constellation phase (step 120) are illustrated in the chart presented in FIG. 4. The example embodiment illustrated in FIG. 4 assumes an optical network that includes 50 channels, with a top subset of 5 channels and a bottom subset of 5 channels. The set of nine pairs of PD values of the constellation set, calculated in step 225, and, the corresponding BER measured in step 230, are depicted in the first row of the chart and subsequent rows by an “X” to represent the various values of P, D applied and the measured BERs for each of the channels. The pair of P, D values with no incremental changes (0, 0) corresponds to the starting PD set with its corresponding BER for each channel.

As also illustrated in FIG. 4, for some embodiments, during the measurements of the BERs for each of the channels, the starting pair of P and D values (e.g., starting PD set) is applied to the channels not included in top subset of the channels or in the bottom subset of the channels (e.g., middle sorted channels 6 through 45).

As further illustrated in FIG. 4, a P/D pair (or some embodiments multiple pairs of the PD pairs) corresponding to a lowest maximum measured BER will result for a sorted subset channel, designated as the top subset of channels, and thereby thereby chosen as part of the best constellation PD set in step 235. For instance, for sorted channels 1, 2, 3 4 and 5, of the top subgroup, the pairs (0, +ΔD), (−ΔP, −ΔD), (−ΔP, +ΔD), (−ΔP, 0) and (0, −ΔD) of the constellation PD set results in the lowest BER of these channels, respectively. As also illustrated for the embodiment shown in FIG. 4, where the power increment is non-zero, oppositely signed power adjustment increments can be applied to the 50th, 49th, 48th, 47th and 46th channels, respectively.

FIG. 5 presents a flowchart illustrating selected steps in the extension phase (e.g., step 130) of the method (e.g., method 100). For the embodiment illustrated in FIG. 5, the extension phase includes a step 510 of calculating change vectors (ΔV) of P and D values. The change vectors are equal to (e.g., determined as) the difference between the best constellation PD set (e.g., from step 125) and the starting pair of P and D values for each of the channels (e.g., from step 110). As further illustrated in FIG. 5 the extension phase includes a step 520 of adding the change vectors to the best constellation PD set to produce an extension PD set. As part of step 520, the extension PD set is checked to ensure that the PD values are still within allowed ranges, similar to that discussed in the context of step 225.

As further illustrated in FIG. 5, the extension phase (e.g., step 130) can also include a step 530 of measuring the BERs for each of the channels of the optical network while applying the pairs of P and D values of the extension PD set to each one (e.g., corresponding one) of the top subset of channels, and, applying corresponding oppositely signed changed P values to the bottom subset of channels. The extension phase (e.g., step 130) can also include a step 540 of choosing the P and D values of the extension PD set as a best extension phase set if in decision step 535, the lowest maximum BER among the channels of the optical network when applying the extension PD set is less than the lowest maximum BER when applying the best constellation PD set (BER_max_extension <BER_max_constellation). If the lowest maximum BER among the channels of the optical network when applying the extension PD set is not less than the lowest maximum BER when applying the best constellation PD set, then the extension phase stops at step 135, and, the best constellation PD set is accepted as the best pairs of PD values to optimize the BER among the channels. If in decision step 535, the lowest maximum BER among the channels of the optical network when applying the extension PD set is less than the lowest maximum BER when applying the best constellation PD set, then in step 540 the best extension PD set can be used as the starting pair of P and D values in a second iteration of the extension phase, and at the end of the extension phase, as discussed in the context of steps 145-150 in FIG. 1, used as a starting PD set in another iteration of the constellation phase (step 120).

As further illustrated in FIG. 5, some embodiments of the extension phase (e.g., step 130) can further included performing a second iteration of the extension phase procedure. As part of a second iteration, in step 545, the same change vectors are added to the best extension phase set from step 540 to produce a another second extension PD set. As part of the second iteration step 545, the second extension PD set is checked to ensure that the PD values are still within allowed ranges. As part of a second iteration, in step 550, the BERs are measured for each of the channels of the optical network while applying each one of the pairs of P and D values of the second extension PD set to each one of the top subset of channels and applying corresponding oppositely signed changed P values to the bottom subset of channels. As part of a second iteration, in a decision step 555, if it is determined if the lowest maximum BER among the channels (e.g., all channels of the optical network) when applying the second extension PD set is less than the lowest maximum BER when applying the (previous) best extension PD set (step 540). If it is decided, in step 555, that the lowest maximum BER when applying the second best extension PD set is lower, then the second extension PD set is set as a best second extension phase set in step 540 and another iteration of the extension phase can be applied. If it is decided in step 555, that the lowest maximum BER when applying the second best extension PD set is not lower, then the previous best extension PD set (e.g., first extension set determined in step 540) is designated in step 140 as the best extension set.

FIG. 6 graphically illustrates an example implementation the method of minimizing bit error ratio presenting example stages of the constellation and extension phase parts of the method at various intermediate iterations the method such as discussed in the context of FIGS. 1-5. FIG. 6 illustrates example stages of an optimization routine for the constellation and extension phase parts of the method for one channel. In various embodiments of the method there could be analogous optimization routines for each of the top and bottom subsets of channels.

With continuing reference to FIG. 1, as illustrated in FIG. 6, as a result of a first iteration of the constellation phase (step 120a) a best constellation PD set is determined (e.g., a constellation pair (−ΔP, −ΔD)). Next, in a first iteration of the extension phase (step 130a) a change vector ΔV1 is applied in a same direction of change as the direction of change of the best constellation PD set and compared to the starting PD set (step 110a). Three additional iterations of the extension phase (steps 130b, 130c, 130d) are performed before reaching stop step 140. The best extension PD set, from the fourth iteration of the extension phase (130d), is used as the starting pair of P and D values (step 110b) in a second iteration of the constellation phase procedure (step 120b) which results in a new best constellation PD step (e.g., another constellation pair (ΔP, 0)). Four additional iterations of the extension phase (steps 130e, 130f, 130g, 130h) are next applied using a different change vector ΔV2 before reaching stop step 140. The fourth iteration of the extension phase (step 130h), is used as the starting pair of P and D values (step 110b) in a third iteration of the constellation phase procedure (step 120c) which does not result in a further reduction in the maximum BER of the channel, resulting in the method terminating at step 135.

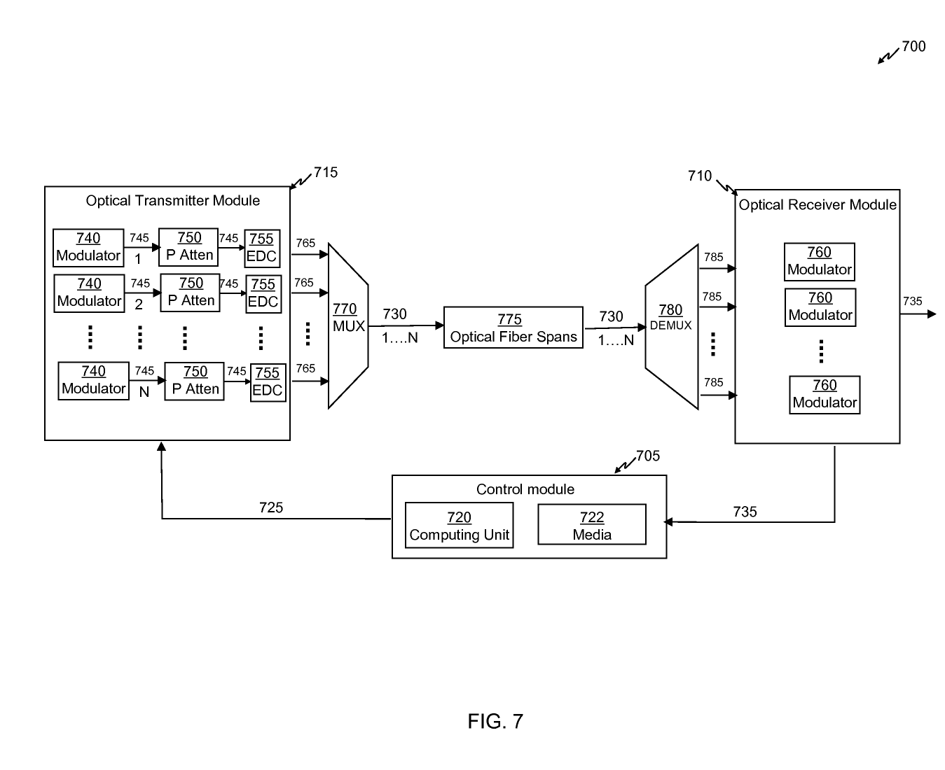

Another embodiment of the disclosure is an apparatus. FIG. 7 presents a block diagram of an example apparatus 700 that can apply the method of optimizing the bit rate as disclosed herein including any of the embodiments of the method discussed in the context of FIGS. 1-6.

With continuing reference to FIG. 1-6, as illustrated in FIG. 7, the apparatus 700 comprises an optical channel balancing control module 705 configured to be electrically connected to an optical receiver module 710 and to an optical transmitter module 715. Although the balancing control module 705 is depicted FIG. 7 as structurally separated from optical receiver and transmitter modules 710, 715 in some embodiments, all or a portion of the control module 705 can be incorporated into optical receiver module 710 or into the optical transmitter module 715. In some embodiments, for instance, portions (e.g., central processing units, CPUs, or graphic processing units, GPUs, on electronic circuit boards) of a computing unit 720 of the control module 705 can reside on the optical receiver transmitter modules 710, 715 and be in communication with other portions (e.g., other CPUs or GPUs) of the computing unit 720.

The computing unit 720 of the control module 705 is configured to send electrical control signals 725 to the optical transmitter module 715. The control signals 725 causes the optical transmitter module 715 to adjust input power levels (P) and electronic dispersion compensation (D) to channels (e.g., channels 1 . . . N) of optical signal streams 730 transmitted from the optical transmitter module 715 to the optical receiver module 710.

The adjusted P and the D values can be determined by ab algorithm (e,g, a computer algorithm) embodied in a computer program executed by the computing unit 720. Embodiments of the computer program can be stored on a non-transitory computer readable medium 722 (e.g., RAM, SRAM, DRAM or other non-transitory memory) in the computing unit 720. One of ordinary skill in the pertinent art would understand how the computing unit 720 can be programmed to execute program code instructions stored in the medium 722 to perform any of the embodiments of the method discussed in the context of FIG. 1-6.

For instance, the computer program includes instructions to execute the constellation phase procedure (step 120). As a preliminary to implementing the constellation phase procedure according to the computer program executed in the computing unit 720, the computing unit 720 is configured to measure BER for each of the channels of the optical signal streams 730 transmitted to the receiver module 710, for a starting pair of P and D values (e.g., in accordance with step 110) applied to each one of the optical signal streams 730 of the channels (e.g., in accordance with step 112). For instance, a part of measuring BER, electronic signal streams 735 (e.g., electrical bit streams), converted from the optical signal stream by the receiver module 720, can be sent to, or monitored by, the control module 705. The computing unit 720 of the control module 720 can be programmed to determine the number of bit errors divided by the total number of transferred bits for defined time interval.

The computing unit 720 is configured to sort the channels from the highest measured BER to the lowest BER (e.g., in accordance with step 210). The computing unit 720 is configured to select a top subset of the channels having the highest BERs and a bottom subset of the channels having the lowest BERs (e.g., in accordance with steps 220, 222). In some embodiments, the number of channels in the bottom subset equals the number of channels in the top subset.

The computing unit 720 is also configured to calculate a constellation set of P and D values that includes the starting pair of P and D values and a set of changed P and D values, wherein for each member of the changed set, one or both of P and D are positively or negatively incremented away from the starting pair of P and D values (e.g., in accordance with step 225). The computing unit 720 is further configured to measure the BERs for each of the channels of the optical network after applying each one of the pairs of P and D values of the constellation set to each one of the top subset of channels and applying corresponding oppositely signed changed P values to the bottom subset of channels (e.g., in accordance with step 230). The computing unit 720 is also configured to choose the P and D values of the constellation set that resulted in a lowest maximum BER among the channels of the optical network as a best constellation PD set (e.g., in accordance with step 235).

As further illustrated in FIG. 7, in some embodiments, the channel balancing control module 705 can be part of the apparatus 700 configured as an optical communication system, and the system further including the optical transmitter module 715. The optical transmitter module 715 can include one or more modulators 740 that are configured convert digital electrical signal streams 745 into the optical signal streams 730. In some embodiments, the modulators 740 include, or are, transponders or transceivers configured to encode the digital electrical signal into the optical signal stream by altering one or more of the phase, amplitude or polarity of the optical signal stream. In some embodiments, the optical transmitter module 715 includes at least one of a power attenuator 750 (P Atten) configured to adjust the P or an electronic dispersion compensator 755 (EDC) configured to adjust the D, as instructed by the computing unit 720. One of ordinary skill would be familiar with electronic devices (e.g., integrated circuit devices) that can be programmed to adjust the dispersion waveform form of an electronic digital signal according to an electronic dispersion compensation algorithm such as instructed by the computing unit 720.

As further illustrated in FIG. 7, in some embodiments, the channel balancing control module 705 can be part of the apparatus 700 configured as an optical communication system, and the system can further include the optical receiver module 710. In some embodiments, the optical receiver module 710 includes one or more transponders or transceivers 760 that are configured (e.g., using photo-detectors) to convert the optical signal streams 730 into a digital electrical signal streams 735.

As further illustrated in FIG. 7, in some embodiments, the channel balancing control module 705 can part of the apparatus 700 configured as an optical communication system, and the system can further include an optical multiplexer 770 configured to combine and multiplex the optical signal streams 765 of the channels into a single wavelength division multiplexed (WMD) optical stream 730. The single WMD optical signal stream 730 can be sent through one or more optical fiber spans 775 to an optical demultiplexer 780 of the system, the optical demultiplexer 780 configured to separate and demultiplex the single WMD optical signal stream 730 into separate optical streams 785 that are received by the optical receiver module 710. In some embodiments, the optical multiplexer 760 can include at least one of a power attenuator 750 configured to adjust the P or an electronic dispersion compensator 755 configured to adjust the D, as instructed by the computing unit 720. Although the transmitter module 715 and optical multiplexer 760 are depicted as separated structures, in some embodiments, these components could be integrated, e.g., on a single component board or card. Similarly, although the receiver module 710 and optical demultiplexer 780 are depicted as separated structures, in some embodiments, these components could be integrated, e.g., on a single component board or card.

Although the present disclosure has been described in detail, those skilled in the art should understand that they can make various changes, substitutions and alterations herein without departing from the scope of the invention.

What is claimed is:

1. A method, comprising:
adjusting input power (P) and electronic dispersion compensation (D) applied to one or more channels of a set of optical channels, including performing a constellation phase procedure including:
for each of the channels, measuring a bit error ratio (BER) that results from a starting PD value pair corresponding to that channel;
selecting a top subset of the channels each having a higher BER than remaining channels in the set of channels, and selecting a bottom subset of the channels each having a lower BER than the remaining channels in the set;
calculating, for each channel of the top and bottom subsets, a constellation set of P and D values that includes the starting pair of P and D values corresponding to that channel and a changed set of P and D values corresponding to that channel, wherein for each member of each changed set one or both of P and D are incremented or decremented from the corresponding starting pair of P and D values;
measuring, for each of the optical channels of the top and bottom subsets, the BER of that channel after applying each one of the pairs of P and D values of the corresponding constellation set to each one of the top subset of channels and applying corresponding oppositely signed changed P values to the bottom subset of channels; and
choosing the P and D values of the constellation set that results in a lowest maximum BER among the channels as a best constellation PD set.

2. The method of claim 1, wherein the best constellation PD set is a single pair of P and D values that results in a lowest maximum BER over all of the channels.

3. The method of claim 1, wherein the best constellation PD set includes multiple pairs of P and D values that result in a lowest maximum BER for each one of the top subset of channels.

4. The method of claim 1, wherein during the measurements of the BERs for each of the channels, the starting pair of P and D values is applied to the remaining subset of channels.

5. The method of claim 1, wherein the best constellation PD set is used as the starting pair of P and D values in a second iteration of the constellation phase procedure.

6. The method of claim 1, wherein adjusting of the P and the D applied to the channels further includes performing an extension phase procedure including the steps of:
calculating a change vector of P and D values equal to the difference between the best constellation PD set and the starting pair of P and D values;
adding the change vector to the best constellation PD set to produce an extension PD set;
measuring the BERs for each of the channels after applying each one of the pairs of P and D values of the extension PD set to each one of the top subset of channels and applying corresponding oppositely signed changed P values to the bottom subset of channels; and
choosing the P and D values of the extension PD set as a best extension phase set if the lowest maximum BER among the channels when applying the extension PD set is less than the lowest maximum BER when applying the best constellation PD set.

7. The method of claim 6, wherein the best extension PD set is used as the starting pair of P and D values in a second iteration of the constellation phase procedure.

8. The method of claim 6, further including performing a second iteration of the extension phase procedure, including:
adding the change vector to the best extension phase set to produce a second extension PD set;
measuring the BERs for each of the channels after applying the pairs of P and D values of the second extension PD set to each one of the top subset of channels and applying corresponding oppositely signed changed P values to the bottom subset of channels; and
choosing the P and D values of the second extension PD set as a best second extension phase set if the lowest maximum BER among the channels when applying the second extension PD set is less than the lowest maximum BER when applying the best extension PD set.

9. The method of claim 8, wherein the best second extension PD set is used as the starting pair of P and D values in a second iteration of the constellation phase procedure.

10. An apparatus, comprising:
an optical channel balancing control module electrically configured to be connected to an optical receiver module and to an optical transmitter module, wherein a computing unit of the control module is configured to:
send electrical control signals to the optical transmitter module to adjust input power levels (P) and electronic dispersion compensation (D) to channels of optical signal streams transmitted from the optical transmitter module to the optical receiver module; and
wherein the adjusted P and the D values are determined by a computer algorithm embodied in a computer program executed by the computing unit, the algorithm including a constellation phase procedure including:
measuring bit-error-ratios (BER) for each of the channels of the optical signal streams transmitted to the receiver module, for a starting pair of P and D values applied to each one of the optical signal streams of the channels;
ordering the channels by measured BER;
selecting a top subset of the channels each having a corresponding BER greater than a remaining subset of the channels, and selecting a bottom subset of the channels each having a corresponding BER less than the remaining subset of the channels;
calculating a constellation set of P and D values that includes the starting pair of P and D values and a set of changed P and D values, wherein for each member of the changed set one or both of P and D are incremented or decremented away from the starting pair of P and D values;
measuring the BERs for each of the channels after applying each one of the pairs of P and D values of the constellation set to each one of the top subset of channels and applying corresponding oppositely signed changed P values to the bottom subset of channels; and
choosing the P and D values of the constellation set that resulted in a lowest maximum BER among the channels as a best constellation PD set.

11. The apparatus of claim 10, wherein the best constellation PD set is a single pair of P and D values that results in a lowest maximum BER over all of the channels.

12. The apparatus of claim 10, wherein the best constellation PD set includes multiple pairs of P and D values that result in a lowest maximum BER for each one of the top subset of channels.

13. The apparatus of claim 10, wherein during the measurements of the BERs for each of the channels, the starting pair of P and D values is applied to the remaining subset of channels.

14. The apparatus of claim 10, wherein adjusting the P and the D applied to the channels further includes performing an extension phase procedure in the computing unit, including the steps of:
calculating a change vector of P and D values equal to the difference between the best constellation PD set and the starting pair of P and D values;
adding the change vector to the best constellation PD set to produce an extension PD set;
measuring the BERs for each of the channels after applying each one of the pairs of P and D values of the extension PD set to each one of the top subset of channels and applying corresponding oppositely signed changed P values to the bottom subset of channels; and
choosing the P and D values of the extension PD set as a best extension phase set if the lowest maximum BER among the channels when applying the extension PD set is less than the lowest maximum BER when applying the best constellation PD set.

15. The apparatus of claim 10, wherein the channel balancing control module is part of the apparatus configured as an optical communication system, and the system further including the optical transmitter module, the optical transmitter module including one or more modulators that are configured convert digital electrical signal streams into the optical signal streams.

16. The apparatus of claim 15, wherein the modulators include transponders or transceivers configured to encode the digital electrical signal into the optical signal stream by altering one or more of the phase, amplitude or polarity of the optical signal stream.

17. The apparatus of claim 15, wherein the optical transmitter module includes at least one of a power attenuator configured to adjust the P or an electronic dispersion compensator configured to adjust the D, as instructed by the computing unit.

18. The apparatus of claim 10, wherein the channel balancing control module is part of the apparatus configured as an optical communication system, and the system further including the optical receiver module, wherein the optical receiver module includes one or more transponders or transceivers that are configured convert the optical signal streams into digital electrical signal streams.

19. The apparatus of claim 10, wherein the channel balancing control module is part of the apparatus configured as of an optical communication system, and the system further including an optical multiplexer configured to combine and multiplex the optical signal streams of the channels into a single wavelength division multiplexed (WMD) optical stream and send the single WMD optical signal stream through one or more optical fiber spans to an optical demultiplexer of the system, the optical demultiplexer configured to separate and demultiplex the single WMD optical signal stream into separate optical streams that are received by the optical receiver module.

20. The apparatus of claim 19, wherein the optical multiplexer includes at least one of a power attenuator configured to adjust the P or an electronic dispersion compensator configured to adjust the D, as instructed by the computing unit.

21. A method, comprising:
determining a first subset of a set of optical channels, each channel of the first subset having a bit error ratio (BER) greater than each channel of a remaining subset of the channels;
determining a second subset of the set of optical channels, each channel of the second subset having a BER less than each channel of the remaining subset of the channels;
adjusting input power level (P) and/or dispersion compensation (D) of one or more of the channels of the first subset thereby reducing an aggregate BER of the first subset; and
adjusting P and/or D of one or more of the channels of the second subset, thereby increasing an aggregate BER of the second subset,
wherein a reduction of an aggregate BER of the set of optical channels results from the adjusting of the first and second subsets.

22. The method of claim 21, wherein an aggregate power level of the set of optical channels remains about equal before and after the adjusting.

23. An apparatus, comprising:
a computing unit;
a non-transitory computer-readable storage medium having instructions stored thereon that when executed by the computing unit configure the computing unit to:
determine a first subset of a set of optical channels, each channel of the first subset having a bit error ratio (BER) greater than each channel of a remaining subset of the channels;
determine a second subset of the set of optical channels, each channel of the second subset having a BER less than each channel of the remaining subset of the channels;
adjust input power level (P) and/or dispersion compensation (D) of one or more of the channels of the first subset thereby reducing an aggregate BER of the first subset; and
adjust P and/or D of one or more of the channels of the second subset, thereby increasing an aggregate BER of the second subset,
wherein a reduction of an aggregate BER of the set of optical channels results from the adjusting of the first and second subsets.

24. The apparatus of claim 23, wherein the computing unit is further configured by the instructions to adjust the input power levels of the first and second subsets such that an aggregate power level of the set of channels remains about equal before and after the adjusting
